(19) United States
(12) Patent Application Publication
(10) Pub. No.: US 2015/0206484 A1
(43) Pub. Date: Jul. 23, 2015

(54) DISPLAY APPARATUS

(71) Applicant: SHARP KABUSHIKI KAISHA, Osaka-shi, Osaka (JP)

(72) Inventor: Toshiyuki Gotoh, Osaka-shi (JP)

(73) Assignee: SHARP KABUSHIKI KAISHA, Osaka-shi, Osaka (JP)

(21) Appl. No.: 14/417,070

(22) PCT Filed: Jul. 19, 2013
(86) PCT No.: PCT/JP2013/069585

§ 371 Date: Jan. 23, 2015

(30) Foreign Application Priority Data
Jul. 24, 2012 (JP) 2012-164173

(51) Int. Cl. G09G 3/34; G09G 3/36

(52) U.S. Cl. CPC G09G 3/3406; G09G 3/3648; G09G 2310/0237; G09G 2310/08; G09G 2320/064

(57) ABSTRACT

Provided is a display apparatus that is possible to reduce the number of drivers required without increasing controllable CHs (channels) in the driver for driving a light emitting device, and aims for reduction in cost and size of the display apparatus.

The display apparatus includes a display panel for displaying an image based on a vertical synchronization signal and a horizontal synchronization signal and a plurality of light emitting devices illuminates the display panel from the back side of the display panel, and turns on and turns off the plurality of light emitting devices divided into several groups. In the display apparatus, the cycle of the vertical synchronization signal is divided into periods equal to the number of the divided light emitting device groups, and turning on and turning off the light emitting devices of each group is performed one after another.

This application is the national phase under 35 U.S.C. §371 of PCT International Application No. PCT/JP2013/69585 which has an International filing date of Jul. 19, 2013 and designated the United States of America.

### BACKGROUND

1. Technical Field

The present invention relates to a display apparatus including a display panel for displaying an image based on a vertical synchronization signal and a horizontal synchronization signal and a plurality of light emitting devices which illuminates the display panel from the back side of the display panel, and turning on and turning off the plurality of light emitting devices divided into several groups.

2. Description of Related Art

Recently, LEDs have been used as a backlight (light source) in a liquid crystal display. It is possible for this type of liquid crystal display to realize so-called local dimming, in which the display is divided into several areas, and the light emissions of LEDs corresponding to the respective areas are independently controlled.

In this way, low power consumption and high contrast are listed as the features in the liquid crystal display in which local dimming is possible. In addition, the more number of areas being a minimum unit for controlling a backlight, the higher its effect can be. However, the number of LED drivers for driving LEDs increases in proportional to an increase in the number of areas, resulting in the increase of a cost.

The number of LED drivers used in a liquid crystal display having a local dimming function is dependent on the number of control areas as the minimum unit for controlling the luminance of a backlight, as described above. For example, in a case where the number of control areas is 16 in horizontal direction and 12 in vertical direction, if one LED driver is a device capable of controlling 16 CHs (channels), one LED driver is required for every 16 horizontal areas, and the number of LED drivers for 12 vertical areas, that is, 12 LED drivers in total are needed. It is assumed that the number of LED drivers can be decreased by further increasing control CHs (channels) in one LED driver; however, there is a problem that heat dissipation of the LED driver itself for driving LEDs increases with an increase of allowable power dissipation. In other words, since the heat dissipation amount increases as increasing controllable CHs (channels) in one LED driver; therefore, it is not desirable as a product.

On the other hand, Japanese Patent Application Laid-Open Publication No. 2010-153359 discloses a display apparatus in which a backlight is divided into two or more areas and light sources (LEDs) arranged in divided areas are in chain-connection; and control areas are selected in a time-division manner and one backlight driving path is shared for driving light sources in a plurality of divided areas.

FIG. 7 is a schematic circuit diagram showing the prior art relating to Japanese Patent Application Laid-Open Publication No. 2010-153359.

With regard to the display apparatus related to Japanese Patent Application Laid-Open Publication No. 2010-153359, a power supply circuit 182, two constant current sources 185a, 185b and a second switch 187 are configured as a semiconductor IC, and a power supply control signal 189 for controlling the power circuit, a constant current control signal 186a for controlling the two constant current sources and a pulse width modulation signal 188 for controlling the second switch are supplied from a light control part not shown.

An anode signal is supplied through a first switch 571a to the anode sides of LED chains 112a, 112c, and also the anode signal is supplied through a first switch 571b to anode sides of LED chains 112b, 112d.

On the other hand, cathode sides of the LED chains 112a, 112b are connected to a cathode signal 572a of the constant current source 185a through signal lines 171a, 171b, and cathode sides of the LED chains 112c, 112d are connected to a cathode signal 572b of the constant current source 185b through signal lines 171c, 171d.

By adopting such a configuration, the display apparatus related to Japanese Patent Application Laid-Open Publication No. 2010-153359 can be realized by scanning backlight control for controlling power feeding to four LED chains 112a to 112d by a combination of ON/OFF control of current in two constant current sources 185a, 185b, and ON/OFF control of two first switches 571a, 571b; therefore, it is possible to configure a circuit with ease at a low price with reduced number of first switches.

### SUMMARY

However, in the display apparatus related to Japanese Patent Application Laid-Open Publication No. 2010-153359 (see the circuit diagram in FIG. 7), since a common anode signal is supplied to LED chains 112a, 112c selected through the first switch 571a or LED chains 112b, 112d selected through the first switch 571b, the respective luminance of LED chains 112a, 112c and LED chains 112b, 112d cannot be controlled.

The present invention has been made in view of these circumstances and has an object to provide a display apparatus that includes a display panel for displaying an image based on a vertical synchronization signal and a horizontal synchronization signal and a plurality of light emitting devices which illuminates the display panel from the back side of the display panel, and turns on and turns off the plurality of light emitting devices divided into several groups, the display apparatus being possible to reduce the number of drivers required (using quantity) without increasing controllable CHs (channels) in a driver for driving a light emitting device by dividing the cycle of the vertical synchronization signal into the periods equal to the number of light emitting device groups and successively turning on and turning off each group, which enables reduction in cost and size of the display apparatus.

A display apparatus according to the present invention includes a display panel for displaying an image based on a vertical synchronization signal and a horizontal synchronization signal which is included in an image signal and a plurality of light emitting devices which illuminate the display panel from the back side of the display panel, and the display apparatus turns on and turns off the plurality of light emitting devices divided into N group where N is larger than or equal to 2. The display apparatus divides the cycle of the vertical synchronization signal into N periods and turns on and turns off each group successively.

In the present invention, for example, in a case where the number “N” of the light emitting device groups is 2, the cycle of the vertical synchronization signal is divided into two periods, and each light emitting device group is turned on and turned off successively within the cycle of one vertical synchronization signal.

The display apparatus according to the present invention includes a power source for supplying power to the light emitting device and a connecting section for performing connection of the power source and any group, and the connecting section performs the connection for each group in accordance with each of the N period.

In the present invention, the connecting section connects the power source to each group of light emitting devices in each of the periods. For example, in a case where the number “N” of groups of the light emitting devices is 2, since the cycle of the vertical synchronization signal is divided into two periods, the connecting section connects the power source to one group in one period, and connects the power source to the other group in the other period.

The display apparatus according to the present invention includes a counter for counting a clock to be inputted in a predetermined cycle, and the counter performs counting the clock in a 1/N-fold cycle.

In the present invention, the clock to be used for the display of an image related to the image signal is inputted in the constant cycle, and the clock is counted by the counter. For example, the number “N” of groups of the light emitting devices is 2, the counter counts in a ½-fold cycle, which is one-half of the constant cycle.

The display apparatus related to the present invention is characterized in that the connecting section performs the connection based on the number of pulse of the horizontal synchronization signal.

In the present invention, for example, in a case where the number “N” of groups of the light emitting devices is 2, the cycle of the vertical synchronization signal is divided into two periods as described above; and the connecting section connects the power source to one group during one period, and connects the power source to the other group during the other period. More particularly, the connecting section connects the power source to one group until a half of the number of pulse of the horizontal synchronization signal is reached, and switches the connection of the power source to the other group when a half of the number of pulse of the horizontal synchronization signal is reached.

The display apparatus related to the present invention includes driving sections equal to the number of the N groups, a PWM control section for PWM control of each of the N groups connected to the power source, through each of the driving section during each of the N periods.

In the present invention, for example, in a case where the number “N” of groups of the light emitting devices is 2 as described above, the PWM control section performs PWM control of each of the N groups concerning one group through the driving section when the power source is connected to said one group.

According to the present invention, it is possible to reduce the number of driver(s) required without increasing controllable CHs (channels) in a driver for driving light emitting devices, and reduction in cost and size of a display apparatus can be achieved.

The above and further objects and features will move fully be apparent from the following detailed description with accompanying drawings.

### BRIEF DESCRIPTION OF THE SEVERAL VIEWS OF THE DRAWINGS

FIG. 1 is a functional block diagram showing the configuration of a main part of a display apparatus according to an embodiment of the present invention;

FIG. 2 is a schematic drawing illustrating the configuration of a main part of a backlight in the display apparatus according to an embodiment of the present invention;

FIG. 3 is a drawing illustrating the relations among a vertical synchronization signal, a clock and a switching signal in the backlight of the display apparatus according to an embodiment of the present invention;

FIG. 4 is a drawing illustrating the relations among a vertical synchronization signal, a horizontal synchronization signal and a switching signal in the backlight of the display apparatus according to an embodiment of the present invention;

FIG. 5 is a drawing illustrating the control of turning on and turning off of a light emitting device in the backlight of the display apparatus related to an embodiment of the present invention;

FIG. 6 is a drawing illustrating the control of turning on and turning off of a light emitting device in the backlight of the display apparatus related to an embodiment of the present invention; and

FIG. 7 is a schematic circuit diagram showing the prior art related to Japanese Patent Application Laid-Open Publication No. 2010-153359.

### DETAILED DESCRIPTION

In the following section, a display apparatus according to the present invention applied to a backlight provided in the display apparatus is described as an example based on the drawings.

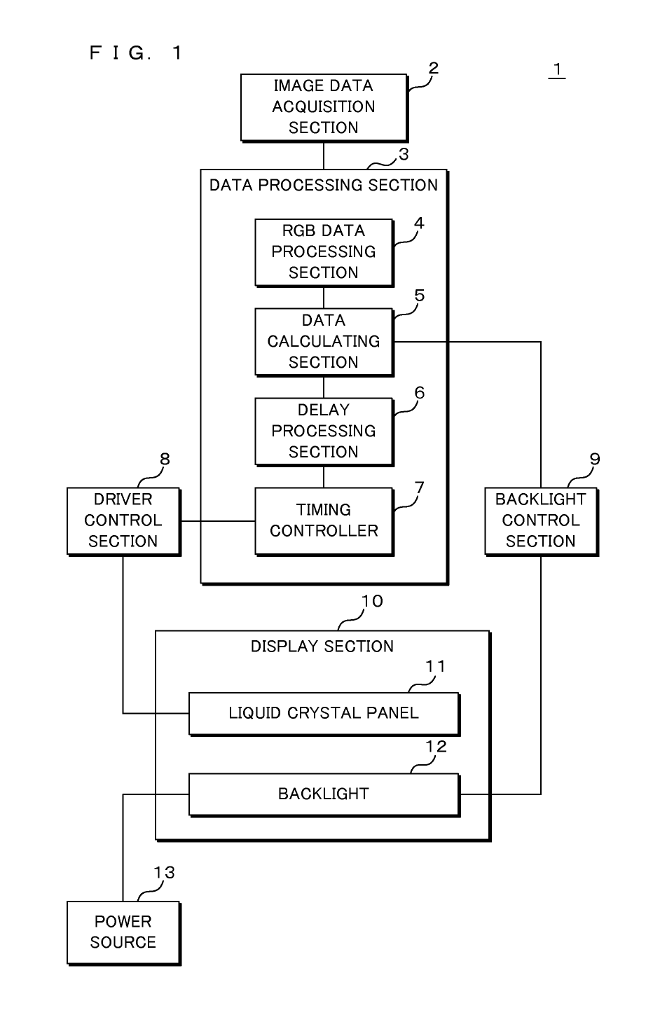

FIG. 1 is a functional block diagram showing the configuration of a main part of display apparatus 1 according to an embodiment of the present invention. The display apparatus 1 includes an image data acquisition section 2, a data processing section 3, a display section 10, a driver control section 8, a backlight control section 9, and a power source 13.

The image data acquisition section 2 acquires, for example, data (for example, a RGB value) related to an image to be displayed in the display section 10 from a storage section not shown (hereinafter referred to as image data). In addition, it is not restricted to this case, but it may also be configured to acquire predetermined image data from outside with connection to a communication network such as a public network by using a network card or modem not shown and a communication network such as LAN (Local Area Network) or Internet. The image data acquisition section 2 selects a variety of input image data and sends the data to the data processing section 3.

The data processing section 3 includes a RGB data processing section 4, a data calculating section 5, a delay processing section 6 and a timing controller 7.

The RGB data processing section 4 converts an input format to RGB data if the input format is not RGB data, and unifies the data format.

The data calculating section 5 performs a variety of image adjustment processing on inputted data. In particular, the data calculating section 5 generates data for a liquid crystal panel such as a liquid crystal panel gray levels to be used in a display of the liquid crystal panel 11 described later, and data for backlight such as a backlight gray levels to be used for the lighting of the backlight 12 described later. In addition, color correction (the adjustment of luminance, chromaticity (saturation), and hue), sharpness adjustment, modification of gamma curve and color temperature and the like are carried out on the data for a liquid crystal panel. The data calculating section 5 further performs processing of local dimming.

The backlight is configured by a plurality of LEDs arranged in a matrix, and the plurality of LEDs are divided in a plurality of control areas in which the adjustment of luminance can be realized individually. Only one LED or a plurality of LEDs may be included in one control area. An image displayed by the liquid crystal panel 11 is divided into a plurality of areas illuminated by a plurality of control areas to be included in the backlight. Each region in the image divided into a plurality regions corresponds to the control area in the backlight one-to-one. In the liquid crystal panel, the part irradiated from the control areas of the backlight corresponding to the respective regions in the image divided into a plurality of regions displays each of the regions of the image. For example, in a case where a backlight is divided into 16×8 control areas and the liquid crystal panel 11 displays an image with 1920×1080 pixels, 120×135 pixels are included in each region of the image. By individually controlling the luminance of control areas in the backlight, local dimming in which the degree of brightness in each area of the image is individually adjusted is performed.

The data calculating section 5 determines individually luminance of each control area of the backlight in view of the amount of light from the control areas surrounding a control area for which luminance is to be obtained. For example, the data calculating section 5 obtains the maximum luminance among pixels in each region of the image, and sets luminance of each control area to a value with which the evaluated luminance may be obtained. In addition, the data calculating section 5 calculates luminance distribution of the backlight in which the luminance in each control area of the backlight is converted to the resolution identical to that of the liquid crystal panel 11. Moreover, the data calculating section 5 performs gamma correction on an image signal, and performs processing of generating data for the liquid crystal panel 11 for operating the liquid crystal panel 11 so as to cause the liquid crystal panel 11 to display an image based on the image signal after gamma correction and luminance distribution of the backlight.

The data for backlight (backlight gray levels) generated by the data calculating section 5 is sent to the backlight control section 9. The backlight control section 9 turns on a backlight 12 based on the data for backlight. That is, the backlight control section 9 carries out driving control of the LED described later, of the backlight 12 with the use of the backlight gray levels. Moreover, the backlight control section 9 outputs a clock (luminance data) to be used for an image display in the backlight 12, in a predetermined cycle (for example, 60 Hz).

In addition, the data for liquid crystal panel generated by the data calculating section 5 (liquid crystal panel gray levels) is sent to a delay processing section 6. In a case where the data for liquid crystal panel is inputted, the delay processing section 6 delays the data for liquid crystal panel for a prescribed time to conform with operation timing of the liquid crystal panel 11 and operation timing of the backlight 12.

The timing controller 7 controls transmittance of each of the pixels in the liquid crystal panel 11 through the driver control section 8 based on data for liquid crystal panel (liquid crystal panel gray levels) generated by the data calculating section 5.

The driver control section 8 controls a source driver and a gate driver (not shown) connected to the liquid crystal panel 11 in accordance with the instruction provided from the timing controller 7, and causes the liquid crystal panel 11 to drive per pixel and display a predetermined image.

The display section 10 has, for example, an LCD panel and displays a predetermined image. In addition, the display section 10 includes the liquid crystal panel 11 and the backlight 12 provided at the back side of the liquid crystal panel 11.

The liquid crystal panel 11 includes a pair of transparent substrates, a liquid crystal layer provided between these transparent substrates, and a plurality of pixels having a color filter, and also displays texts, images or the like with the use of light from the backlight 12.

The backlight 12 includes an optical sheet group not shown, a diffusion plate and a circuit board with three color light emitting diodes (LED) of red (R), green (G) and blue (B). The LED circuit board is provided in a matrix shape. The backlight 12 controls each of the LEDs, and emits light in white color or other colors.

The power source 13 supplies power to the display section 10 (backlight 12), and has a so-called constant voltage circuit. A light emitting device of the backlight 12, which is described later, is connected to the constant voltage circuit. The voltage of the constant voltage circuit is determined by the forward voltage of the light emitting device.

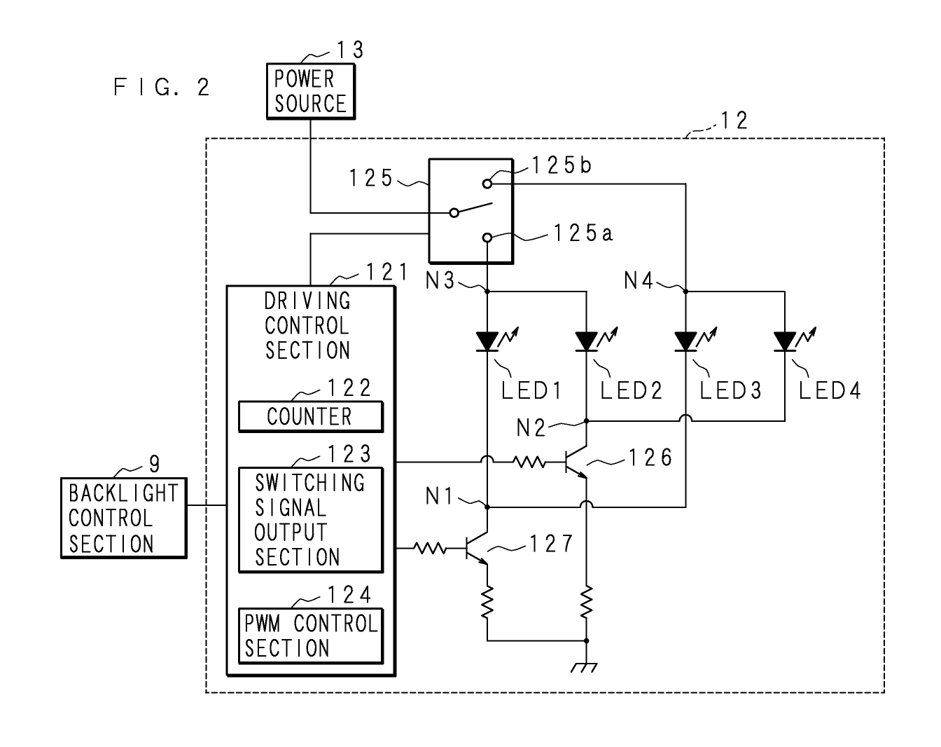

FIG. 2 is a schematic drawing illustrating the essential configuration of the backlight 12 in the display apparatus 1 according to an embodiment of the present invention. The following section describes an example in which the backlight 12 includes four light emitting devices (LEDs) and is divided into two light emitting device groups for convenience of explanation.

The backlight 12 includes a driving control section 121, a connecting section 125, four light emitting devices LED 1 to LED 4, and LED drivers 126, 127.

The light emitting devices LEDs 1 to 4 include light emitting diodes (LEDs) respectively, and includes LED drivers of only the number of light emitting devices related to the light emitting device groups described later, that is, two LED drivers 126, 127. The LED drivers 126, 127 include transistors, and drive (turn on and turn off) light emitting devices LED 1 to LED 4.

In particular, the light emitting devices LED 1 and LED 3 are connected to the LED driver 127, and the light emitting devices LED 2 and LED 4 are connected to the LED driver 126. In other words, the light emitting devices LED 1 and LED 3 are turned on and turned off by the LED driver 127, and the light emitting devices LED 2 and LED 4 are turned on and turned off by the LED driver 126.

The connecting section 125 is interposed between the power source 13 and the light emitting devices LED 1 to LED 4, and connects the power source 13 to the light emitting devices LED 1 and LED 2 or the light emitting devices LED 3 and LED 4 in response to the switching signal described later, to be outputted from the driving control section 121.

For further detail, in a case where the connecting section 125 connects the power source 13 to the first terminal 125a, a voltage is applied to the light emitting devices LED 1 and LED 2, and the light emitting devices LED 1 and LED 2 are all turned on by the LED drivers 127 and 126 respectively. In addition, in a case where the connecting section 125 connects the power source 13 to the second terminal 125b, a voltage is applied to the light emitting devices LED 3 and LED 4, and the light emitting devices LED 3 and LED 4 are all turned on by the LED drivers 127 and 126 respectively. In the following section, the light emitting devices LED 1 and LED 2 are referred to as a light emitting device group 1, and the light emitting devices LED 3 and LED 4 are referred to as a light emitting device group 2.

The driving control section 121 drives the light emitting devices LED 1 to LED 4 in response to the instruction of the backlight control section 9. The driving control section 121 includes a counter 122, a switching signal output section 123, and a PWM control section 124.

The counter 122 counts a clock to be inputted from the backlight control section 9 in a predetermined cycle and to be used for luminance control in the backlight 12 based on the image data. The counter 122 gives notice of the count result to, for example, the switching signal output section 123, the PWM control section 124 or the like, and the switching signal output section 123 and the PWM control section 124 output the switching signal and perform PWM control respectively in response to the notification from the counter 122.

Moreover, the counter 122 changes a counting cycle in accordance with the number of light emitting device groups. As described above, in a case where the vertical synchronizing cycle is 60 Hz (original cycle), the backlight control section 9 outputs a clock corresponding to the bit number of the counter. For example, if the counter shows 10 Bit/1023, then a clock whose cycle is 1024 times 60 Hz (61.44 kHz) is outputted.

That is, in a case where a clock from the backlight control section 9 is counted by a 10 Bit/1023 counter, 1023 is counted “N” times within the original cycle. In the present embodiment, since the light emitting device group 1 and the light emitting device group 2 exist, “N” is “2” and thus the counter 122 counts the clock in a “½”-fold cycle of the original cycle, that is, a frequency of 122.88 kHz which corresponds to “2”-folds of the frequency of the original cycle, the clock (1023) is counted twice in the original cycle.

The switching signal output section 123 transmits to the connecting section 125 a switching signal for instructing the switching of a connection corresponding to a notification from the counter 122. As the switching signal is received from the switching signal output section 123, the connecting section 125 switches the connection with the power source 13 from the light emitting device group 1 to the light emitting device group 2, or from the light emitting device group 2 to the light emitting device group 1.

According to the present embodiment, every time the counter 122 counts the clock (1023) at 120 Hz, the counter 122 notifies the switching signal output section 123 of the fact, and the connecting section 125 switches the connection with the power source 13 accordingly. The present invention is not restricted to this case, but every time the counter 122 counts the clock (1023) at 120 Hz, the counter 122 notifies the PWM control section 124 of the fact.

The PWM control section 124 performs PWM control on the light emitting devices LED 1 to LED 4 in accordance with the notification from the counter 122 (or switching signal output section 123). That is, the PWM control section 124 outputs a PWM signal for controlling the luminance of the light emitting devices LED 1 to LED 4 based on a signal from the backlight control section 9. In a case where the PWM signal is “Low,” the light emitting devices LED 1 to LED 4 are turned on. In a case where the PWM signal is “High,” the light emitting devices LED 1 to LED 4 are turned off.

For example, a vertical synchronization signal, a horizontal synchronization signal, a clock signal and luminance data are inputted to the backlight 12 from the backlight control section 9. In a case where the clock from the backlight control section 9 is counted by a counter in an accuracy of 10 Bits as described above, DUTY corresponding to each PWM signal is 100% if the clock has a value of 1023. In this case, the counter 122 starts counting along with the start of a vertical synchronization signal, and the PWM control section 124 continues to output a “Low” PWM signal until conforming with the luminance value. Because when the counter 122 counts 1023, the vertical synchronization signal changes to the next and DUTY corresponds to 100%. On the other hand, when a clock is 512, the PWM control section 124 continues to output a “Low” PWM signal until 512 is counted by the counter 122, and when 512 is counted the PWM control section 124 outputs a “High” PWM signal so that DUTY corresponds to 50%.

On the other hand, according to the present embodiment, such PWM control is performed for each light emitting device group in accordance with the counting of a clock in a cycle of 120 Hz by the counter 122, in other words, in accordance with the output of a switching signal from the switching signal output section 123. Accordingly, the PWM controls of the light emitting device group 1 and the light emitting device group 2 are successively performed within the vertical synchronization signal of one cycle.

In the following section, the configuration of the driving circuit of the backlight 12 is described in detail. As described above, the light emitting device LED 1 and the light emitting device LED 3 are driven by the LED driver 127, and the light emitting device LED 2 and the light emitting device LED 4 are driven by the LED driver 126.

In particular, the anodes of the light emitting device LED 1 and the light emitting device LED 2 are connected to the first terminal 125a of the connecting section 125 through a node N3. On the other hand, the cathode of the light emitting device LED 1 is connected to the collector of the LED driver 127 through a node N1 which has connection with the light emitting device LED 3. The cathode of the light emitting device LED 2 is connected to the collector of the LED driver 126 through a node N2 which has connection with the light emitting device LED 4.

The anodes of the light emitting device LED 3 and the light emitting device LED 4 are connected to the second terminal 125b of the connecting section 125 through a node N4. On the other hand, the cathode of the light emitting device LED 3 is connected to the collector of the LED driver 127 through the node N1, and the cathode of the light emitting device LED 4 is connected to the collector of the LED driver 126 through the node N2.

On the other hand, the bases of the LED driver 126 and the LED driver 127 are connected to the driving control section 121 respectively through resistance. The emitters of the LED driver 126 and the LED driver 127 are connected to a GND level respectively through resistance. The LED driver 126 and the LED driver 127 become on or off state in response to the instruction from the driving control section 121, and the light emitting device LEDs 1 to 4 are turned on and turned off in accordance therewith.

In the following section, the control of turning on and turning off of the light emitting devices LED 1 to LED 4 of the backlight 12 is described in detail.

For example, as described above, when a cycle of a vertical synchronization signal from the backlight control section 9 is 60 Hz and the bit accuracy of a counter is, for example, 10 bits, the counter 122 counts a clock at a cycle of 122.88 KHz, and the switching signal output section 123 outputs the switching signal in accordance with the counting of the counter 122.

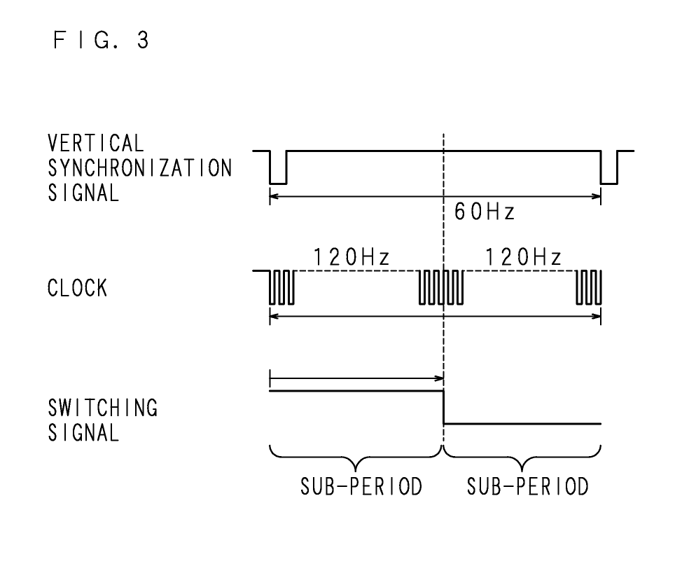

FIG. 3 is a drawing that illustrates the relations among a vertical synchronization signal, a clock, and a switching signal in the backlight 12 of the display apparatus 1 related to an embodiment of the present invention. After the vertical synchronization signal is reset, the counter 122 starts counting of the clock at a cycle of 120 Hz. At this time, the switching signal output section 123 outputs a “High” switching signal. On the other hand, the switching signal output section 123 outputs a “Low” switching signal at a point of time when the counter 122 counts 1023.

In other words, one vertical synchronization signal cycle is divided into sub-periods equal to the number of the light emitting device groups, and a clock (1023) is counted for each sub-period. The switching signal output section 123 outputs a “Low” switching signal or “High” switching signal for each sub-period. In the present embodiment, since the light emitting device group 1 and the light emitting device group 2 exist, the number of light emitting device groups is “2,” one vertical synchronization signal cycle is divided into two sub-periods, and in a sub-period, the counter 122 counts a clock at a cycle of further “½” of the 1024 times in the vertical synchronization signal cycle (60 Hz), that is, in a “2”-fold frequency (122.88 KHz).

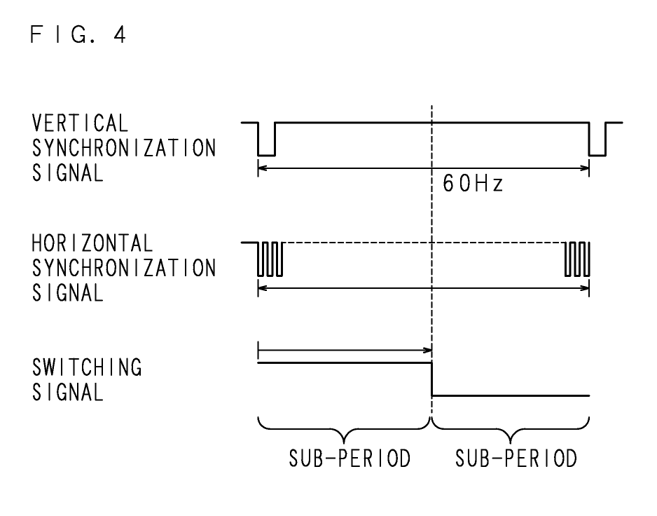

The present invention is not restricted to this case, but may be configured to use a horizontal synchronization signal instead of a clock. FIG. 4 is a drawing illustrating the relations among a vertical synchronization signal, a horizontal synchronization signal and a switching signal in the backlight 12 of the display apparatus 1 related to an embodiment of the present invention.

In such a circumstance, the switching signal output section 123 outputs a switching signal based on the counting result of a horizontal synchronization signal in a cycle of a vertical synchronization signal. For example, in a case of a Full HD video image (1920×1080), the pulse of a horizontal synchronization signal is normally generated 1125 times in one cycle of a vertical synchronization signal. Accordingly, after resetting a vertical synchronization signal, for example, the counter 122 starts counting of the horizontal synchronization signal. At this time, the switching signal output section 123 outputs a “High” switching signal. Subsequently, the switching signal output section 123 may output a “Low” switching signal at a point of time when the counter 122 counts a half of 1125.

Moreover, the present invention is not restricted to this case, but may be configured to use a so-called DE signal (data enabling signal) instead of the clock.

If the switching signal is made into, for example, 2 bits, even in the case where one vertical synchronization signal cycle is divided into four sub-periods, the switching signal output section 123 can output a switching signal in accordance therewith.

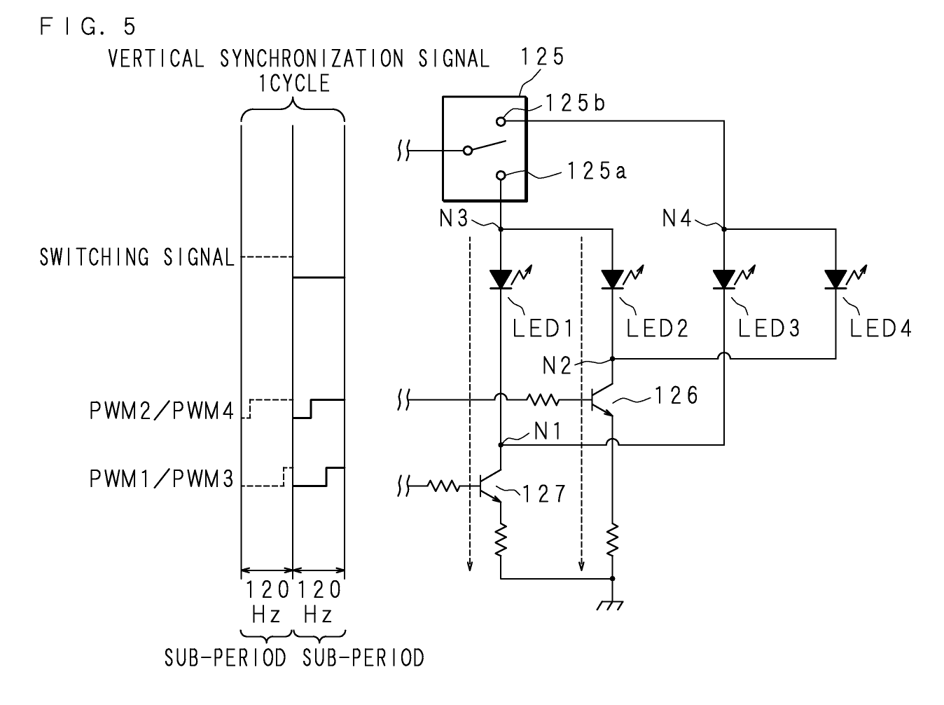

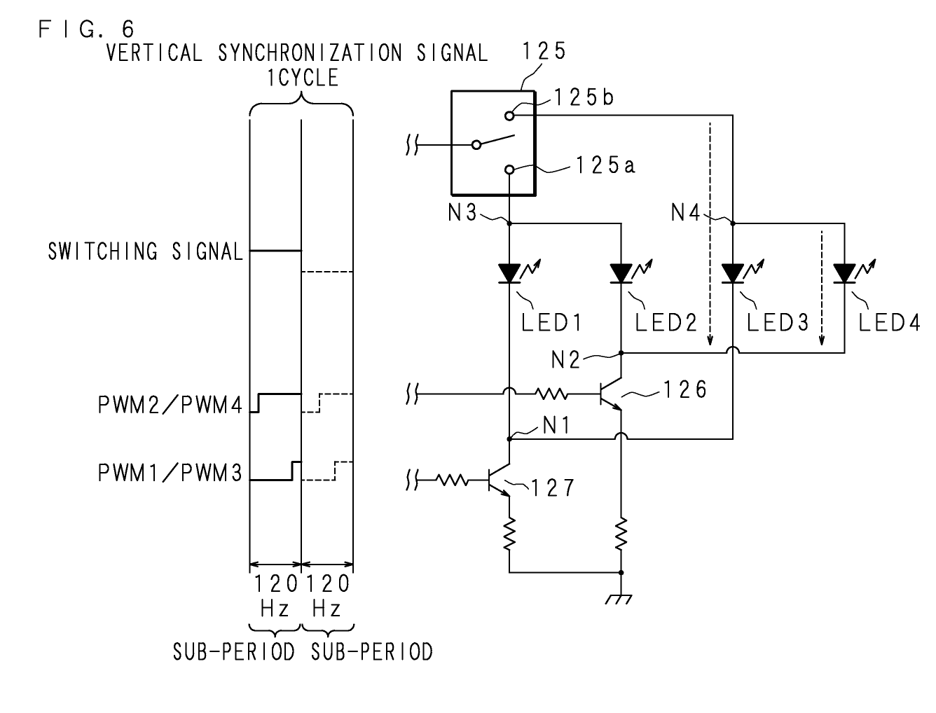

FIGS. 5 and 6 are drawings that illustrate turning on and turning off of the light emitting devices LED 1 to LED 4 in the backlight 12 of the display apparatus 1 according to an embodiment of the present invention.

The light emitting device group LED 1 to LED 4 are connected to the power source 13 through the connecting section 125, and are turned on in a case where a corresponding PWM signal is “Low.” For convenience of explanation, the PWM signal related to luminance control of the light emitting device LED 1 is hereinafter referred to as PWM 1, the PWM signal related to luminance control of the light emitting device LED 2 is hereinafter referred to as PWM 2, the PWM signal related to luminance control of the light emitting device LED 3 is hereinafter referred to as PWM 3, and the PWM signal related to luminance control of the light emitting device LED 4 is hereinafter referred to as PWM 4.

The connecting section 125 connects the power source 13 to the light emitting device group 1 or the light emitting device group 2 in response to a switching signal from the switching signal output section 123. That is, in a case where a “High” switching signal (expressed by the dotted line in FIG. 5) is outputted, the connecting section 125 connects the power source 13 to the first terminal 125a, and a voltage is supplied (expressed by the dotted arrows in FIG. 5) to the light emitting device group 1 (light emitting device LED 1 and light emitting device LED 2).

At this time, the LED driver 127 turns on the light emitting device LED 1 based on the PWM 1 (expressed by the dotted lines in FIG. 5) to be outputted from the PWM control section 124, the LED driver 126 turns on the light emitting device LED 2 based on the PWM 2 (expressed by the dotted lines in FIG. 5) to be outputted from the PWM control section 124.

In other words, luminance control is performed based on the PWM 1 and PWM 2 relative to the light emitting device LED 1 and the light emitting device LED 2 while a “High” switching signal from the switching signal output section 123 is outputted as an output signal, that is, during the sub-period. Note that such luminance control is performed at 120 Hz.

Hereinafter, as described above, the switching signal output section 123 outputs a “Low” switching signal at the intermediate point of the cycle of the vertical synchronization signal, that is, at the time when the counter 122 counts 1023 (see FIG. 3) or when the counting of the counter 122 reaches a half of the horizontal synchronization signal (1125) (FIG. 4). At this time, the connecting section 125 connects the power source 13 to the second terminal 125b, and a voltage (expressed by the dotted arrow in FIG. 6) is supplied to the light emitting device group 2 (the light emitting device LED 3 and the light emitting device LED 4).

At this time, the LED driver 127 turns on the light emitting device LED 3 based on the PWM 3 (expressed by the dotted line in FIG. 6) to be outputted from the PWM control section 124, the LED driver 126 turns on the light emitting device 4 based on the PWM 4 (expressed by the dotted line in FIG. 6) to be outputted from the PWM control section 124. At this time, the light emitting device group 1 (the light emitting device LED 1 and the light emitting device LED 2) is turned off.

In other words, luminance control is performed based on the PWM 3 and the PWM 4 relative to the light emitting device LED 3 and the light emitting device LED 4 while a “Low” switching signal from the switching signal output section 123 is outputted as an output signal, that is, during the sub-period. The luminance control is performed at 120 Hz.

The vertical synchronization signal is reset subsequently, and turning on and turning off control of the light emitting device LED 1 to LED 4 above-mentioned are repeated within the cycle of one vertical synchronization signal.

As described above, in the display apparatus 1 according to the present invention, since the light emitting device LEDs are divided into “N” light emitting device groups; the cycle of one vertical synchronization signal is divided into N sub periods; and each light emitting device group is turned on and turned off one after another, “N” LED drivers are adequate for driving the light emitting device LEDs.

In the present embodiment, there are four light emitting device LEDs, these light emitting device LEDs are divided into two light emitting device groups and each light emitting device group is turned on and turned off one after another in the cycle of one vertical synchronization signal. Therefore two LED drivers are adequate without the need of providing LED drivers only for light emitting device LEDs in a liquid crystal panel performing local dimming. In other words, the number of LED drivers to be required can be reduced by a half. Accordingly, it is possible to reduce cost or further reduce cost drastically along with minimization in the area of a circuit board by the simplification of a circuit with the reduction in number of components.

For example, in a case where light emitting device LEDs are divided into three light emitting device groups and each light emitting device group is turned on and turned off one after another within the cycle of one vertical synchronization signal, the number of LED drivers to be required can be reduced by ⅓.

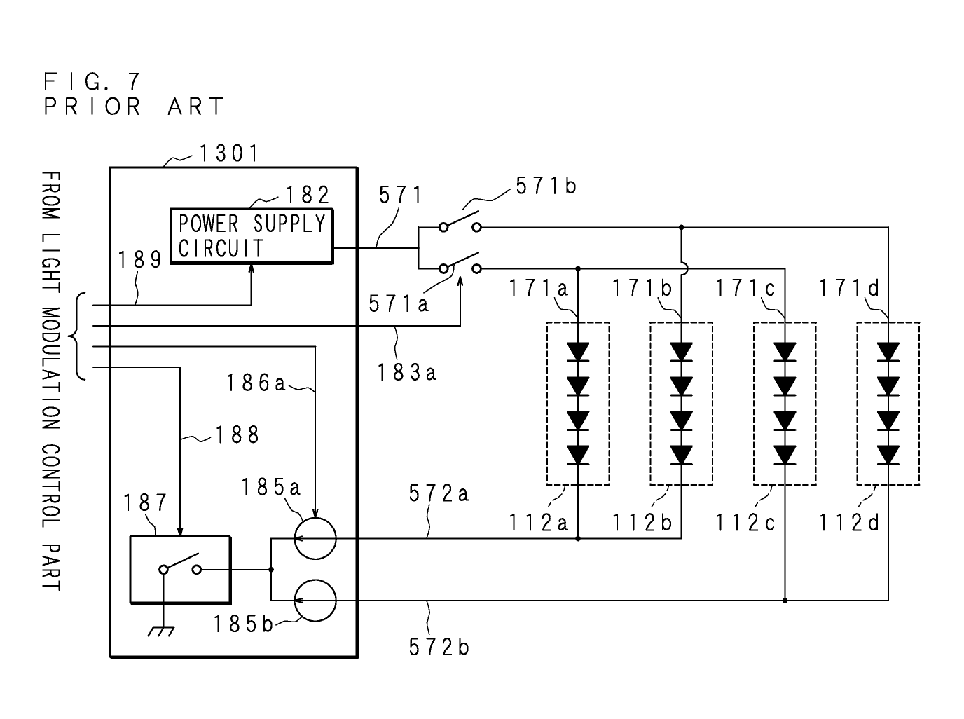

Moreover, in the conventional display apparatus shown in FIG. 7, each of the light emitting devices cannot be controlled individually. However, in the present embodiment, it is possible that the LED drivers 126, 127 control luminance individually on the light emitting device LED 1 to LED 4 in the sub-period.

In the conventional display apparatus shown in FIG. 7, since luminance is controlled by the constant current control, it is difficult to perform luminance control precisely. The present embodiment can control luminance precisely by using a constant voltage circuit.

The present invention is not restricted to the above description. In the above example, the luminance for each light emitting device LED may be configured to be two times the conventional method responding to dividing the cycle of one vertical synchronization signal into two portions at a temporal axis.

In the above description, the LED driver 126 turns on and turns off the light emitting device LED 2 and light emitting device LED 4 one after another, and the LED driver 127 turns on and turns off the light emitting device LED 1 and the light emitting device LED 3 one after another. However, the present invention is not restricted to this case, but a so-called LED chain may be turned on and turned off.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1-6. (canceled)

7. A display apparatus comprising a display panel for displaying an image based on a vertical synchronization signal and a horizontal synchronization signal which is included in an image signal and a plurality of light emitting devices which illuminate the display panel from the back side of the display panel, and turning on and turning off the plurality of light emitting devices which are divided into N groups where N is an integer larger than or equal to two, wherein
a cycle of the vertical synchronization signal is divided into N periods, and the light emitting devices of each group is turned on and turned off one after another.

8. The display apparatus according to claim 7, comprising:
a power source for supplying power to the light emitting device;
and a connecting section for performing connection of the power source and any of the N groups, wherein
the connecting section is configured to perform the connection for each group in accordance with each of the N period.

9. The display apparatus according to claim 7, comprising a counter for counting a clock to be inputted in a predetermined cycle, wherein
the counter is configured to count the clock in a 1/N-fold cycle.

10. The display apparatus according to claim 8, comprising a counter for counting a clock to be inputted in a predetermined cycle, wherein
the counter is configured to count the clock in a 1N-fold cycle.

11. The display apparatus according to claim 8, wherein
the connecting section is configured to perform the connection based on the number of pulse of the horizontal synchronization signal.

12. The display apparatus according to claim 8, comprising:
driving sections equal to the number of the N groups;
and a PWM control section for performing PWM control of each of the N groups connected to the power source, through each of the driving section during each of the N periods.
